(19) United States
(12) Patent Application Publication
(10) Pub. No.: US 2015/0021842 A1
(43) Pub. Date: Jan. 22, 2015

(54) FIXTURE FOR ATTACHING HOMOGENIZER OF CONCENTRATOR SOLAR RECEIVER

(71) Applicant: ATOMIC ENERGY COUNCIL - INSTITUTE OF NUCLEAR ENERGY RESEARCH, TAOYUAN COUNTY (TW)

(72) Inventors: HWA-YUH SHIN, TAOYUAN COUNTY (TW); YI-PING LIANG, TAOYUAN COUNTY (TW); HUNG-SHENG CHIU, TAOYUAN COUNTY (TW); HWEN-FEN HONG, TAOYUAN COUNTY (TW)

(21) Appl. No.: 13/945,005

(22) Filed: Jul. 18, 2013

(51) Int. Cl. G02B 27/62; G02B 27/09; B25B 11/00; H01L 31/042

(52) U.S. Cl. CPC G02B 27/62; H02S 40/00; G02B 27/0994; B25B 11/00
USPC 269/287

(57) ABSTRACT

A fixture for attaching a homogenizer of a concentrator solar receiver is revealed. By fixing bodies and a sleeve being connected to or separated from each other, a homogenizer is attached firmly with adhesive in an inverted cone-shaped space. Moreover, an installation position and the adhesion height of the homogenizer can be controlled precisely. Thus time and labor consumed in assembling the homogenizer are dramatically reduced and good adhesion performance is achieved.

### BACKGROUND OF THE INVENTION

1. Fields of the Invention

The present invention relates to a fixture for attaching a homogenizer, especially to a fixture for attaching a homogenizer of a concentrator solar receiver.

2. Descriptions of Related Art

Solar cells are devices that convert solar energy into electricity using the photoelectric effect. During the power generation process, there is no greenhouse including carbon dioxide, nitrogen oxides, sulfur oxides, etc and pollutant gases generated. Solar energy is a non-consumptive and renewable resource. Due to exhaustion of the earth's resources and the increase of energy cost, solar energy has received great attention in 21 century. Within our daily lives, strategies and issues, companies and products associated with solar power will attract the gaze of everyone and get capital infusion. Thus inexhaustible, nonpolluting solar energy is an ultimate source of green energy that brings prosperity to our lives.

However, there is still a long way to go to make sustainable long term use of solar energy. There are still many improvements that could be made such as stability, service life or cost of solar power techniques.

Solar power is the conversion of sunlight into electricity, by directly sunlight onto solar (photovoltaic) cells. In order to improve power generation efficiency, concentrator solar modules with mirrors or lenses that concentrate more sunlight are used. Fresnel lenses are arranged over the solar cells. The Fresnel lens is a cheap lightweight lens of short focal length. Thus large-diameter Fresnel lens is used to concentrate sunlight to solar cells. After sunlight being focused by the Fresnel lens, it is concentrated and entering a transparent light pipe whose shape is inverted-pyramid. The transparent light pipe is a homogenizer. A bottom of the homogenizer is a smooth flat surface and the homogenizer is used to make energy of light spots concentrated by the Fresnel lens distribute evenly. Once the energy of light spots is not homogenized by the homogenizer and is directly emitted to the solar cells, the energy is highly concentrated so that photoelectric conversion efficiency will decrease. Moreover, the sunlight incident angle is not fixed and is varied with time. Thus the concentrator solar module is used in combination with a sun tracking system. The sun tracking system timely adjusts the operation angle to get the optimal one. The homogenizer is used to improve angle tolerance of the sun tracking system and size tolerance during module assembly. Thus, it is a component of importance and function.

Yet, most of the homogenizers available now are assembled manually. During the assembly process of the homogenizer, the homogenizer is a component whose shape is an inverted conic solid so that the adhesion of the homogenizer is not easy to be controlled precisely. Refer to FIG. 1, a homogenizer 5 is adhered to a solar cell 62 on an insulating substrate 61 with the assistance of a support 10. An electrode area is not shown in the figure. The homogenizer 5 is set on uncured adhesive 9 manually. Thus an adhesive-overflow problem may occur because that the adhesive 9 is pushed by the force applied. The adhesive 9 is pushed downward to surfaces on four sides of the homogenizer 5. The excess adhesive 9 around the surface on four sides of the homogenizer 5 will result in loss of light energy. When light is reflected within the homogenizer 5, light originally not loss will be scattered and emitted from surfaces attached with the adhesive 9 to the outside. Thus the light energy reaching the concentrator solar cell 62 is reduced and the solar power efficiency is lowered.

Moreover, before the adhesive 9 curing, the homogenizer 5 is still in an unstable state and is easily to get inclined, displacement, or even collapsed. The adhesion quality is dramatically reduced. Furthermore, the height of the homogenizer 5 during the adhesion process is difficult to control manually. Once the adhesion height of the homogenizer 5 is not even, the optical quality of the concentrator solar receiver constructed is also affected.

Thus, the improper adhesion of the homogenizer may cause the concentrator solar receiver to have defects and lower efficiency. There is room for improvement and a need to provide a fixture for attaching a homogenizer of a concentrator solar receiver that solves the above problems.

### SUMMARY OF THE INVENTION

It is a primary object of the present invention to provide a fixture for attaching a homogenizer of a concentrator solar receiver in which a space for receiving the homogenizer is formed by a detachable three-piece structure. Users only need to mount the homogenizer into the space, the homogenizer is precisely attached to a proper position on a concentrator solar cell module of the concentrator solar receiver.

It is another object of the present invention to provide a fixture for attaching a homogenizer of a concentrator solar receiver by which users can complete attachment of the homogenizer for reducing labor and time required.

It is a further object of the present invention to provide a fixture for attaching a homogenizer of a concentrator solar receiver that includes two fixing bodies each of which has a notch. The notches of the fixing bodies provide support to the homogenizer during an adhesion process. Thus the homogenizer will not collapse before curing of adhesive. Thus it is ensured that the homogenizer is fixed on the concentrator solar cell module vertically.

It is a further object of the present invention to provide a fixture for attaching a homogenizer of a concentrator solar receiver in which the homogenizer drops down naturally to be adhered with adhesive due to gravity. There is no need to apply any force to the homogenizer. Thus an adhesive-overflow problem caused by over-push of the homogenizer can be minimized. Moreover, due to fixed structure of the fixture, the drop distance of the homogenizer within the adhesive is the same. Thus the distance between the homogenizer and the solar cell can be controlled precisely.

In order to achieve the above objects, a fixture for attaching a homogenizer of a concentrator solar receiver of the present invention includes a first fixing body having a first notch that is wide at the top and narrow at the bottom, a second fixing body disposed on one side of the first fixing body and having a second notch that is wide at the top and narrow at the bottom, and a sleeve disposed around the first fixing body and the second fixing body for holding and fixing the first fixing body and the second fixing body. The second notch of the second fixing body is connected to the first notch of the first fixing body to form a space. Under such structure, the shortcomings of attaching the homogenizer manually can be overcome. Moreover, not only the adhesion efficiency is improved, the performance and service life of the product are also increased.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing adhesion of a prior art;

FIG. 2 is an explosive view of an embodiment according to the present invention;

FIG. 3 is a perspective view showing a part of structure according to the present invention;

FIG. 4A is a schematic drawing showing a cross section of an embodiment before adhesion according to the present invention;

FIG. 4B is a schematic drawing showing a cross section of an embodiment during adhesion according to the present invention;

FIG. 4C is a schematic drawing showing a cross section of an embodiment after adhesion according to the present invention;

FIG. 5 is a partial explosive view of another embodiment according to the present invention;

FIG. 6A is a schematic drawing showing a cross section of another embodiment before adhesion according to the present invention;

FIG. 6B is a schematic drawing showing a cross section of another embodiment during adhesion according to the present invention;

FIG. 6C is a schematic drawing showing a cross section of another embodiment after adhesion according to the present invention;

FIG. 6D is a schematic drawing showing a cross section of another embodiment while removing fixing bolts after adhesion according to the present invention.

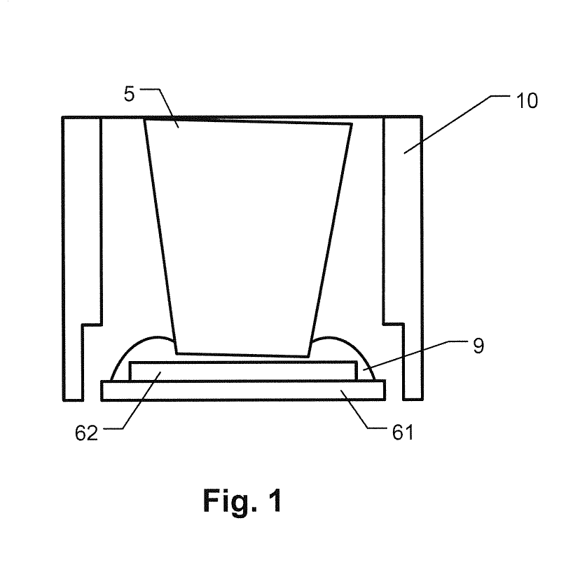

### DETAILED DESCRIPTION OF THE PREFERRED EMBODIMENT

In order to overcome shortcomings generated during adhesion process of conventional approach, the present invention is provided to solve the problem.

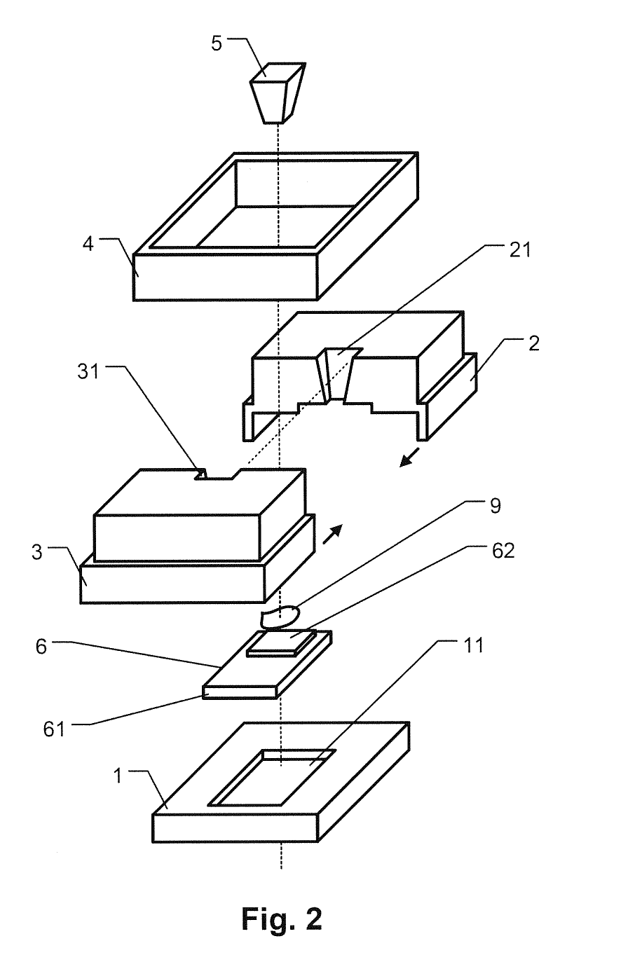

Refer to FIG. 2, a fixture for attaching a homogenizer of a concentrator solar receiver of the present invention includes a fixing base 1, a first slot 11, a first fixing body 2, a first notch 21, a second fixing body 3, a second notch 31 and a sleeve 4.

The first slot 11 is located on the fixing base 1 while the first fixing body 2 and the second fixing body 3 are both disposed over the fixing base 1. The first fixing body 2 and the second fixing body 3 respectively include the first notch 21 and the second notch 32. The sleeve 4 is arranged around and enclosing the first fixing body 2 and the second fixing body 3 to fasten and connect the first fixing body 2 and the second fixing body 3.

Still refer to FIG. 2, a user can set a concentrator solar receiver 6 without being attached with the homogenizer 5 on the first slot 11 of the fixing base 1. The concentrator solar receiver 6 consists of an insulating substrate 61, a surface electrode area (not shown in figure), and a solar cell 62. The size of the insulating substrate 61 is the same with the size of the first slot 11 so that the concentrator solar receiver 6 can be fixed on the first slot 11 stably.

After the concentrator solar receiver 6 being set, the first fixing body 2 and the second fixing body 3 are disposed over the fixing base 1. The first fixing body 2 and the second fixing body 3 are respectively arranged with the inverted cone-shaped first notch 21 and the inverted cone-shaped second notch 31. After being connected by the first fixing body 2 and the second fixing body 3, an inverted cone-shaped space is formed between the first notch 21 and the second notch 31. This space that is wide at the top and narrow at the bottom just matches the size and shape of the homogenizer 5. In other words, the depth of this space is about the same or a bit smaller than the height of the homogenizer 5. Thus there is no space for the homogenizer 5 to move around when the homogenizer 5 is mounted in the space. Thus the homogenizer 5 is positioned precisely. At the same time, there is no excess adhesive 9 flowed to side surfaces of the homogenizer 5 to cause the adhesive-overflow problem.

There is a homogenizer 5 on a solar cell 62 of each concentrator solar receiver 6. For precise positioning, the inverted cone-shaped space of the present invention is just located above the solar cell 62 during manufacturing of the homogenizer 5. While using the present invention, the surface of the solar cell 62 on the concentrator solar receiver 6 fixed on the fixing base 1 is already coated with the adhesive 9. After the first fixing body 2 and the second fixing body 3 being set on the fixing base 1, the user only need to gently put the homogenizer 5 into the inverted cone-shaped space constructed between the first notch 21 and the second notch 31. The installation of the homogenizer 5 is completed conveniently and precisely.

The homogenizer 5 has a certain weight and the shape of each homogenizer 5 is the same. Thus the homogenizer 5 will fall down naturally due to gravity and fit closely to the inverted cone-shaped space that is wide at the top and narrow at the bottom. At the same time, the bottom of the homogenizer 5 is in contact with the adhesive 9. During the installation of the homogenizer 5, it is difficult to control the adhesive height of the homogenizer 5. That means the depth of the narrow bottom part of the homogenizer 5 inserted into the adhesive 9. However, the adhesive height can be uniformed by the present invention. The adhesion of each homogenizer 5 is standardized. Thus operation quality of the concentrator solar receiver is improved.

Moreover, no adhesive-overflow caused by over push of the homogenizer 5 occurs because that the homogenizer 5 is no more pushed manually.

In the present invention, there is no component used to connect the first fixing body 2 to the second fixing body 3. Such design is for separating the first fixing body 2 and the second fixing body 3 easily after completing the adhesion and the adhesive 9 being cured by some processes such as heating. And there is no need to use a tool or apply a force to separate the first and the second fixing bodies 2, 3 that may have certain impact on the homogenizer 5. In the present invention, the first fixing body 2 and the second fixing body 3 can be directly removed from the left side and the right side of the device. However, in order to prevent the first fixing body 2 and the second fixing body 3 from being separated during the adhesion process, a sleeve 4 is used to fix these two fixing bodies 2, 3. The inner circumference of the sleeve 4 matches the outer circumference of the connected first fixing body 2 and the second fixing body 3. Thus the structure will not become loose before curing of the adhesive 9.

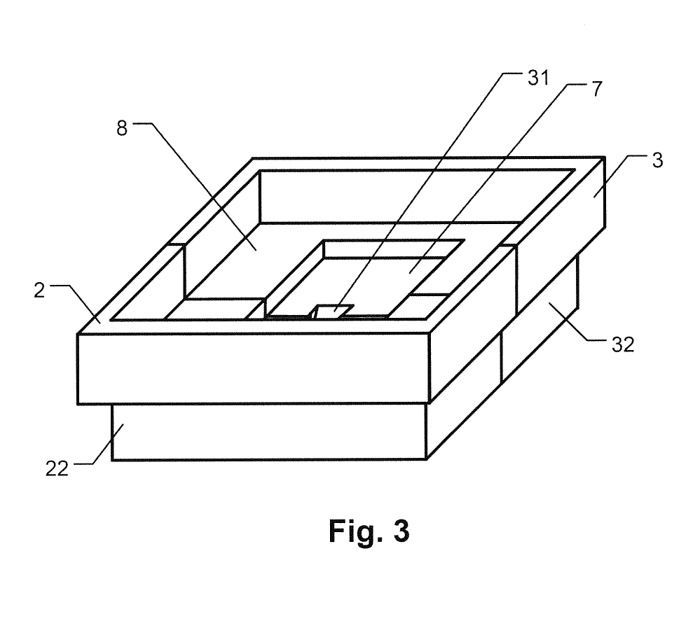

In order to make the structure of the present invention become more stable, refer to FIG. 3, after the first fixing body 2 and the second fixing body 3 connected to each other, a larger third slot 8 and a smaller second slot 7 are observed from a bottom view. The second slot 7 and the first slot 11 are combined to clip the concentrator solar receiver 6 therein. Thus the depth of a space constructed by the first slot 11 and the second slot 7 is equal to or larger than the height of the concentrator solar receiver 6. As to the third slot 8, it is formed by the first fixing body 2 and the second fixing body 3 and used for enclosing and covering the fixing base 1.

One side of the first fixing body 2 and one side of the second fixing body 3 respectively include a first concave side 22 and a second concave side 32. By the first concave side 22 and the second concave side 32, the sleeve 4 can also fasten the fixing base 1 immovably while fixing the first fixing body 2 and the second fixing body 3. After being enclosed by the sleeve 4, a rectangular solid with smooth surfaces and edges is formed. Thus the fixture for attaching can also be delivered into a heating device for curing the adhesive 9 after the installation of the homogenizer 5.

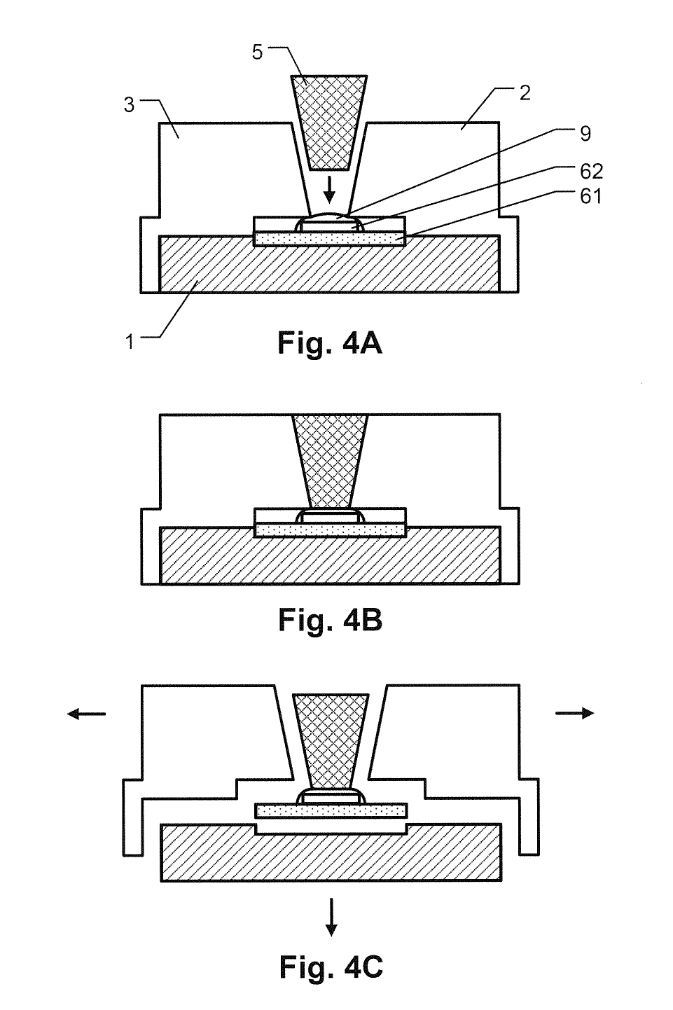

Refer from FIG. 4A to FIG. 4C, an adhesion process of the homogenizer 5 with an embodiment of the present invention is revealed. When the fixing base 1, the first fixing body 2, the second fixing body 3, the concentrator solar receiver 6 and the adhesive 9 have been settled down, the user only needs to insert the homogenizer 5 into the embodiment. After being heated, the adhesive 9 is cured. Then the fixing base 1, the first fixing body 2, and the second fixing body 3 are removed. During the process, the sleeve 4 is used to fasten other components and fix the structure yet is not shown in the figure.

Once users want to adhere and fix a concentrator solar receiver 6 already attached with a homogenizer 5 on the substrate, another embodiment is used to prevent possible breakage or damages to the structure of the concentrator solar receiver 6 during the adhesion process and ensure stability of the homogenizer 5.

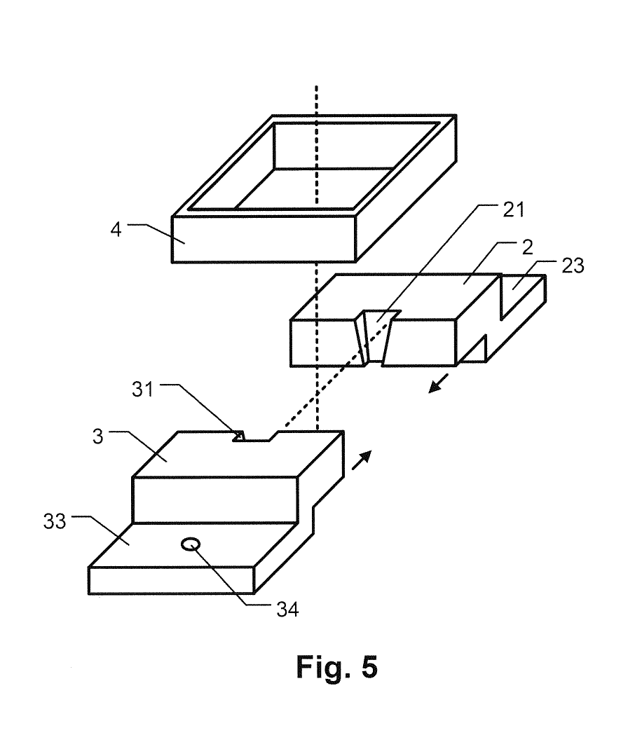

Refer to FIG. 5, a first fixing body 2 and a second fixing body 3 are respectively designed to have a first extension pat 23 and a second extension part 33. The extension parts are used to connect to the substrate already fixed with a concentrator solar receiver 6. The concentrator solar receiver 6 is received in a space under the first fixing body 2 and the second fixing body 3. In order to be fixed on the substrate precisely, the first extension pat 23/the second extension part 33 is arranged with a first fixing hole 24 (not shown in figure)/a second fixing hole 34 and a fastening element such as a bolt is used to fix the first body 2 as well as the second fixing body 3.

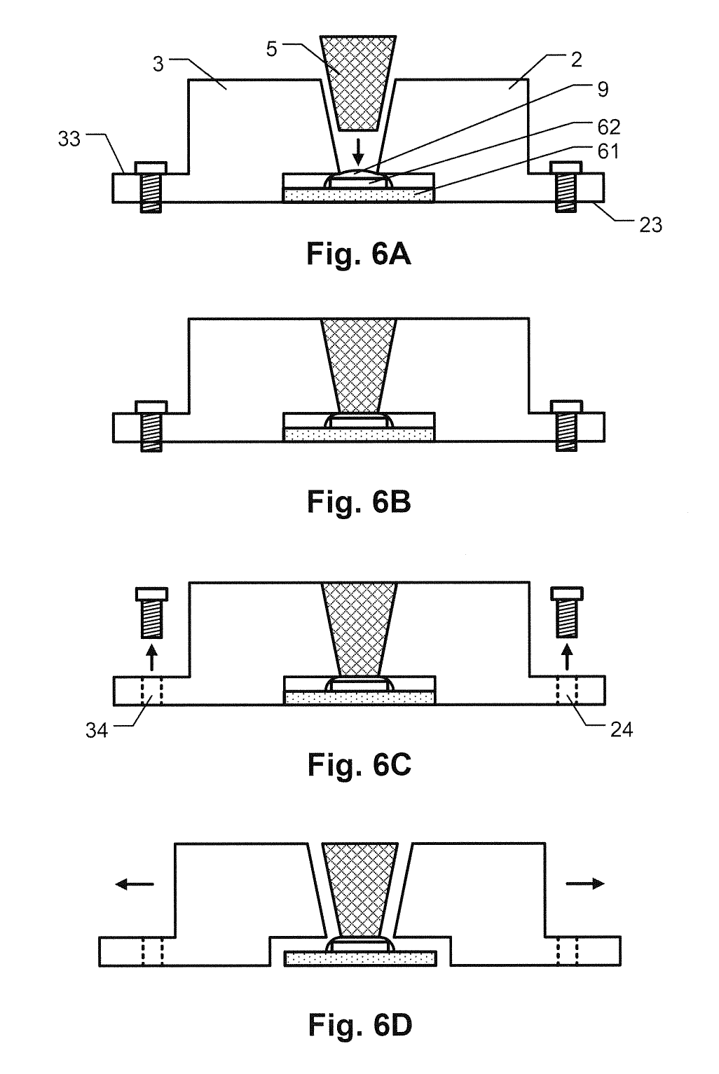

Finally refer from FIG. 6A to FIG. 6D, an adhesion process of the homogenizer 5 with an embodiment of the present invention is revealed. When the first fixing body 2 and the second fixing body 3 have already been fixed on the substrate with the concentrator solar receiver 6 and the adhesive 9 has been applied, the user only need to insert the homogenizer 5 into the embodiment. After curing of the adhesive 9, the bolts in the fixing hole 24 and the second fixing hole 34 are removed. Then the first fixing body 2 and the second fixing body 3 are taken off. Moreover, there is a sleeve 4 used to fix the whole structure during the adhesion process but not shown in the figure.

In summary, the homogenizer has less adhesive failure and better adhesion quality by using a fixture for attaching a homogenizer of a concentrator solar receiver. The inverted cone-shaped homogenizer works stably in combination with a sun tracking system without collapsing easily. This results in a longer service life of the homogenizer. When the adhesion is performed on an uneven surface, it is ensured that the homogenizer gets enough support before curing of the adhesive. Moreover, the assembling efficiency is significantly increased. Both the labor and the time consumed are saved. Therefore the fixture for attaching a homogenizer of a concentrator solar receiver has high economic value.

Additional advantages and modifications will readily occur to those skilled in the art. Therefore, the invention in its broader aspects is not limited to the specific details, and representative devices shown and described herein.

Accordingly, various modifications may be made without departing from the spirit or scope of the general inventive concept as defined by the appended claims and their equivalents.

What is claimed is:

1. A fixture for attaching a homogenizer of a concentrator solar receiver comprising:
a first fixing body having a first notch that is wide at the top and narrow at the bottom;
a second fixing body disposed on one side of the first fixing body and having a second notch that is wide at the top and narrow at the bottom while the second notch is connected to the first notch of the first fixing body; and
a sleeve arranged around the first fixing body and the second fixing body for holding and fixing the first fixing body and the second fixing body;
wherein the first notch and the second notch are connected to form a space used for receiving a homogenizer.

2. The device as claimed in claim 1, wherein a depth of the space is not larger than the height of the homogenizer.

3. The device as claimed in claim 1, wherein the fixture for attaching a homogenizer of a concentrator solar receiver further includes a fixing base with a first slot while the first slot is used to fix a concentrator solar receiver.

4. The device as claimed in claim 3, wherein after the first fixing body and the second fixing body are connected, a second slot and a third slot are formed on a bottom of the first fixing body and the second fixing body connected to each other.

5. The device as claimed in claim 4, wherein the second slot is used to secure the concentrator solar receiver.

6. The device as claimed in claim 5, wherein a depth of the first slot together with a depth of the second slot is not smaller the height of the concentrator solar receiver.

7. The device as claimed in claim 4, wherein the third slot is used to fasten the fixing base immovably.

8. The device as claimed in claim 3, wherein a first concave side is arranged at one side of the first fixing body.

9. The device as claimed in claim 3, wherein a second concave side is disposed on one side of the second fixing body.

10. The device as claimed in claim 1, wherein the first fixing body further includes a first extension part and a first fixing hole is disposed on the first extension part.

11. The device as claimed in claim 1, wherein the second fixing body further includes a second extension part and a second fixing hole is arranged at the second extension part.
